(19) United States
(12) Patent Application Publication
(10) Pub. No.: US 2018/0099798 A1
(43) Pub. Date: Apr. 12, 2018

(54) PACKAGING MATERIALS FOR FOOD PRODUCTS

(71) Applicant: Mary Ruth Lehrter, Cincinnati, OH (US)

(72) Inventor: Mary Ruth Lehrter, Cincinnati, OH (US)

(73) Assignee: Sugar Creek Packing Co., Hamilton, OH (US)

(21) Appl. No.: 15/729,175

(22) Filed: Oct. 10, 2017

Related U.S. Application Data
(60) Provisional application No. 62/406,244, filed on Oct. 10, 2016.

(51) Int. Cl. B65D 81/02; B32B 27/06; B32B 27/32; B32B 5/18

(52) U.S. Cl. CPC B65D 65/44; B32B 27/065; B29C 47/0026; B32B 5/18; B32B 27/322

(57) ABSTRACT

Provided herein are packaging materials that include a non-foamed layer and a foamed layer including a polyethylene.

### CROSS-REFERENCE TO RELATED APPLICATIONS

This application claims the benefit of the filing date of U.S. Provisional Application No. 62/406,244, which was filed on Oct. 10, 2016. The contents of U.S. Application No. 62/406,244 are incorporated by reference in their entirety as part of this application.

### TECHNICAL FIELD

The present disclosure relates to packaging materials for food products, and more particularly to coextruded blown films having a foamed layer of high density polyethylene, low density polyethylene, or both.

### BACKGROUND

Packaging materials for meats, such as bacon, are typically made from cellulosic materials combined with wax and, optionally, a polymeric coating thereon. A common structure includes an uncoated lightweight paperboard that is saturated with molten wax to fill internal voids between fibers while minimizing residual surface wax. That composite web is subsequently extrusion coated with polyethylene on both sides to provide both a slightly rough food contact surface and an opposite side smooth print surface. The wax impregnated into the paperboard minimizes edgewise wicking or penetration of liquids from the meat. The polyethylene coatings provide protection of the wax surface from abrasion and a surface capable of yielding the required level of ink adhesion and print fidelity.

Meatpackers and retailers often desire a specific color as background for the food product that is packed. That can be achieved either through the use of pigmentation of the polyethylene coating on that side of the structure, or through printing that side and overcoating that printing with protective coatings or varnishes. Following printing, the roll or sheet stock is die cut into individual pieces, often referred to as “bacon boards” or “L-boards,” that are subsequently used as supports to carry the meat through packaging equipment, where polymeric films on the top and bottom of the meat and board combination are vacuum shrink-packed and sealed for distribution and sale.

There are several well-known problems associated with such currently used structures. Despite the use of the impregnating wax into the paperboard, edge wicking and staining are not eliminated and become increasingly evident as the food products, such as bacon, go through distribution. Low molecular weight components of the wax have a tendency to migrate to the surface of the wax impregnated paperboard and interfere with the adhesion of the polymer coating layers, and, afterward, the low molecular weight components of the wax can also migrate through the polyethylene layers to the surfaces and can interfere with obtaining or maintaining adequate adhesion of printing inks.

The die-cut edges of these types of materials may not always conform adequately to the meat, and, where they protrude, can cause punctures in the outer shrink wrap surrounding the meat. The wax impregnation step, followed by a separate application of the polymer surface layers, is a multi-step process with complex interactions between wax impregnation variables and subsequent polymer coating operations. This structure frequently is a source of package failure, causing numerous product recalls and disposals.

Accordingly, there is a need for improved packaging materials for food products that overcome the aforementioned shortcomings of current packaging materials. Additionally, there is a need for a continuous manufacturing process of food product packaging materials, which would save time and money. Use of less complex manufacturing sequences with fewer interlayer interactions would reduce the likelihood of delamination and ink adhesion problems and the concomitant potential for food product loss. More particularly, there is a need for a continuous manufacturing process that produces a paper-like material out of a thermoplastic material, which has improved structural integrity through refrigerated distribution and during freeze and thaw cycles, and has sufficient strength and stiffness properties to be printable on at least one side, while minimizing the use of polymeric materials, reducing the weight per unit area, or both compared to current processes. Additionally, the packaging material should be able to be cut, perforated, and/or folded and run with little or no modifications to converting machinery and meat packaging machinery.

### SUMMARY

Packaging materials having one or more of the benefits identified in the background section are disclosed herein. Also, the packaging materials are manufacturable using a continuous process.

Provided herein is a packaging material that includes a non-foamed layer and a foamed layer. The foamed layer includes about 20 wt. % to about 100 wt. % of a polyethylene and about 0 wt. % to about 80% wt. % filler particles. Further, the foamed layer includes foamed cells. The non-foamed layer and the foamed layer are a coextruded blown film.

In some embodiments, the polyethylene is a low density polyethylene. The low density polyethylene can have a melt index of about 0.1 to about 2.0 g/10 min. For example, the low density polyethylene can have a melt index of about 0.2 g/10 min to about 1.0 g/10 min.

In some embodiments, the foamed layer includes about 20 wt. % to about 100 wt. % of a low density polyethylene. For example, the foamed layer can include about 70 wt. % to about 80 wt. %. of a low density polyethylene.

The polyethylene of the foamed layer can also be a high density polyethylene. The high density polyethylene can have a melt index of about 0.01 g/10 min to about 1 g/10 min. In some embodiments, the high density polyethylene of the foamed layer has a weight average molecular weight (M_{w}) of about 200,000 g/mol to about 3,000,000 g/mol. In some embodiments, the high density polyethylene has a number average molecular weight (Mₙ) of about 200,000 g/mol to about 3,000,000 g/mol.

In some embodiments, the foamed layer includes about 20 wt. % to about 60 wt. % of a high density polyethylene.

The foamed layer can include about 10 wt. % to about 40 wt. % of the filler particles, such as about 20 wt. % to about 30 wt. % of the filler particles. The filler particles can have a mean particle size of 0.05 μm to about 10 μm or about 0.1 μm to about 5 μm. The filler particles can be a calcium carbonate, a sodium carbonate, a barium sulfate, a calcium sulfate, a sodium sulfate, a sodium phosphate, a potassium phosphate, and a calcium phosphate, or a combination thereof. In some embodiments, the filler particles are a calcium carbonate. For example, the filler particles can be a calcium carbonate having a mean particle size of about 0.05 μm to about 10 μm or about 0.1 μm to about 5 μm.

The foamed layer can have a thickness of about 0.5 mil to about 10 mil.

The foamed cells of the foamed layer can be formed at least in part from a foaming agent during extrusion. The foaming agent can be a chemical foaming agent, a supercritical fluid, or a combination thereof. In some embodiments, the chemical foaming agent is an endothermic chemical foaming agent. The chemical foaming agent can be an azo-based compound, a carbonate-based compound, a hydrazide-based compound, or a combination thereof.

The non-foamed layer of the packaging material can include a high density polyethylene. The high density polyethylene can have a melt index of about 0.01 g/10 min to about 1 g/10 min. For example, the high density polyethylene can have a melt index of about 0.40 to about 0.50 or about 0.7 g/10 min to about 0.9 g/10 min, such as about 0.8 g/10 min. The high density polyethylene can be about 20 wt. % to about 60 wt. % of the non-foamed layer.

The non-foamed layer can include filler particles. In some embodiments, the filler particles include a calcium carbonate. For example, the non-foamed layer can include about 40 wt. % to about 80 wt. % of calcium carbonate as filler particles. In some embodiments, the non-foamed layer includes about 50 wt. % to about 70 wt. % of calcium carbonate as filler particles.

The non-foamed layer of the packaging material can have a thickness of about 0.5 mil to about 5 mil.

The packaging material can include two non-foamed layers on opposite sides of the foamed layer (e.g. a foamed core layer). In some embodiments, the non-foamed layer is a printable non-foamed layer. One of the non-foamed layers can also be a meat contact layer. The meat contact layer can include a colorant.

In some embodiments, the packaging material includes two non-foamed layers on opposite sides of the foamed layer and two intermediate non-foamed layers on opposite sides of the foamed layer. The first intermediate non-foamed layer can be between the first non-foamed layer and the foamed layer. The second intermediate non-foamed layer can be between the second non-foamed layer and the foamed layer.

In some embodiments, the packaging material has a total thickness of about 5 mil to about 20 mil.

Also provided herein is a packaging material that includes a first non-foamed layer, a first intermediate non-foamed layer, a foamed layer, a second intermediate non-foamed layer, and a second non-foamed layer. The first non-foamed layer includes a high density polyethylene and calcium carbonate filler particles. The first intermediate non-foamed layer includes a high density polyethylene and calcium carbonate filler particles. The foamed layer includes about 60 wt. % to about 90 wt. % of a low density polyethylene, about 10 wt. % to about 40 wt. % of calcium carbonate filler particles, and foamed cells. The second intermediate non-foamed layer includes a high density polyethylene and calcium carbonate filler particles. The second non-foamed layer includes a high density polyethylene and calcium carbonate filler particles. Further, the first non-foamed layer, the first intermediate non-foamed layer, the foamed layer, the second intermediate non-foamed layer, and the second non-foamed layer are a coextruded blown film.

Further provided herein is a packaging material that includes an outer foamed layer, an intermediate foamed layer, a foamed core layer, an intermediate non-foamed layer, and an outer non-foamed layer. The outer foamed layer includes a high density polyethylene, calcium carbonate filler particles, and foamed cells formed from a foaming agent (e.g., a chemical foaming agent, a supercritical fluid, or both). The intermediate foamed layer includes a high density polyethylene, calcium carbonate filler particles, and foamed cells formed from a foaming agent (e.g., a chemical foaming agent, a supercritical fluid, or both). The foamed core layer includes about 60 wt. % to about 90 wt. % of a low density polyethylene, about 10 wt. % to about 40 wt. % of calcium carbonate filler particles, and foamed cells formed at least in part from supercritical nitrogen. The intermediate non-foamed layer includes a high density polyethylene and calcium carbonate filler particles. The outer non-foamed layer includes a high density polyethylene and calcium carbonate filler particles. Further, the outer foamed layer, intermediate foamed layer, foamed core layer, intermediate non-foamed layer, and outer non-foamed layer are a coextruded blown film.

Also provided herein is a packaging material that includes a non-foamed layer and a foamed layer. The foamed layer includes about 40 wt. % to about 80 wt. % of a high density polyethylene and filler particles. The foamed layer has cavitated cells proximate filler particles and foamed cells resulting from the presence of a foaming agent. The non-foamed layer and the foamed layer are a coextruded blown film.

In some embodiments, the foaming agent is a chemical foaming agent, a supercritical fluid, or a combination thereof.

In some embodiments, the non-foamed layer includes a printable material.

The foamed layer can be the innermost layer of the coextruded blown film. The foamed layer can also contribute a surface roughness to a surface of the coextruded blown film upon which bacon or other meat is seated of about 1 to about 7 Sa μm. The surface roughness can be determined using a 3D optical surface profiler.

In some embodiments, the packaging material further includes an additional layer (e.g. a core layer) between the non-foamed layer and the foamed layer. This additional layer can include high density polyethylene, filler particles, and cavitated cells resulting from the presence of the filler particles.

In some embodiments, the foamed layer further includes a nucleating agent, such as a talc-filled polyolefin.

In some embodiments, the non-foamed layer can also be a corona treated layer.

In some embodiments, the coextruded multilayer blown film has a thickness of about 100 μm to about 300 μm.

The filler particles can include a surface treated compacted material having a mean particle size of about 0.05 μm to about 10 μm. The surface treated compacted material can include calcium carbonate as about 75% to about 98% by weight thereof.

In some embodiments, the filler particles include a material selected from calcium carbonate, talc, clay, mica, wood flour, modified starch, or a combinations thereof. For example, the filler particles can include a calcium carbonate having a mean particle size of about 0.05 μm to about 10 μm.

The coextruded multilayer blown film can have more than three layers in which at least two of the layers on the side of the core opposite the non-foamed layer are foamed layers. The packaging material can also include additional layers between the non-foamed layer and the foamed layer, additional film layers on the side of the foamed layer opposite the non-foamed layer, or both.

Also provided herein is a method for making a packaging material disclosed herein. The method includes providing at least one foamable composition including a polyethylene, filler particles, and a foaming agent and at least one non-foamable composition. The method further includes coextruding the at least one foamable composition and the at least one non-foamable composition to form the packaging material.

In some embodiments, the foaming agent of the at least one foamable composition is supercritical nitrogen. In some embodiments, the polyethylene of the at least one foamable composition is a low-density polyethylene.

### BRIEF DESCRIPTION OF THE DRAWINGS

FIG. 1 is a plan view of a traditional bacon board.

FIG. 2 is an image of a section of a surface of a foamed layer according to an exemplary embodiment of the disclosed packaging materials for food products, as captured by QCapture Pro software 12.5× magnification in microns.

FIG. 3 is a digital microscope image, at a lens magnification of 35×, of a longitudinal cross-section of the disclosed packaging material, formed as a blown film of three coextruded layers of high density polyethylene.

FIG. 4 is a digital microscope image, at a lens magnification of 35×, of a longitudinal cross-section of the disclosed packaging material, formed as a blown film of three coextruded layers with a core high density polyethylene (HDPE) having a melt index of 0.04.

FIG. 5 is a digital microscope image, at a lens magnification of 35×, of a longitudinal cross-section of the disclosed packaging material, formed as a blown film of three coextruded layers with a core HDPE having a melt index of 0.45.

FIG. 6 is a digital microscope image, at a lens magnification of 35×, of a longitudinal cross-section of the disclosed packaging material, formed as a blown film of three coextruded layers with a core HDPE having a melt index of 0.8.

FIG. 7 schematically shows an exemplary embodiment of a packaging material having three layers.

FIG. 8 schematically shows an exemplary embodiment of a packaging material having five layers including four non-foamed layers.

FIG. 9 schematically shows an exemplary embodiment of a packaging material having five layers including three foamed layers and two non-foamed layers.

FIG. 10 is a chart of data from Taber Stiffness Analysis of films.

FIG. 11 is a sequential arrangement of microscopic images of a droplet of bacon grease on cellulosic waxed-poly coated bacon board taken over a period of 6 days.

FIG. 12 is a sequential arrangement of microscopic images of a droplet of bacon grease on coextruded, multilayer high density polyethylene (HDPE) film having a foamed layer of the disclosed packaging material, taken over a period of 6 days.

### DETAILED DESCRIPTION

Provided herein are packaging materials that include a non-foamed layer and a foamed layer including a polyethylene. Examples of the packaging materials are illustrated in the accompanying drawings. In the drawings, like reference numbers indicate identical or functionally similar elements.

As used herein, the term “polyethylene” refers to ethylene homopolymers or copolymers made of ethylene and at least one other comonomer.

The packaging materials are described herein with reference to food products such as bacon or other animal proteins, including pork, beef, lamb, turkey, fish (e.g. smoked fish) and other seafood, and processed meats such as bologna, sausage, and game. The disclosed packaging materials may also be useful for packaging other high moisture or fat-containing food products, such as cheese, butter, and other dairy products, as well as fruits and vegetables including root vegetables and legumes. These food products may be packaged in either a raw or cooked state, and the animal protein may be whole or whole muscle, bone-in or boneless, and ground or pureed, such as a pate. Fruit and vegetables may be whole, sliced, or chopped.

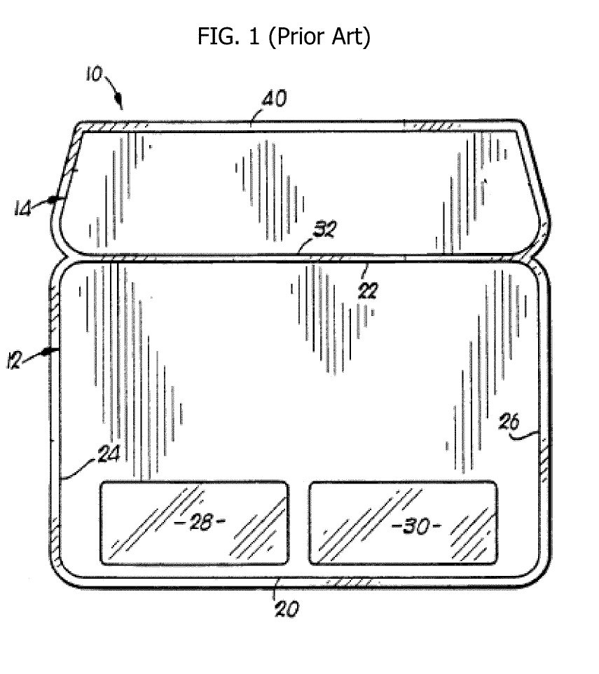

As shown in FIG. 1, a conventionally shaped bacon-supporting board 10 (also known as “bacon board”) includes a relatively large, generally rectangular, sheet-like base section 12, and an elongated, sheet-like flap 14 having a width less than that of the base section 12. The base section 12 has, based on the orientation of the drawing to the page, a lower edge 20, an upper edge 22, a left edge 24, and a right edge 26. The base section 12 may include one or more windows 28, 30 therethrough. As illustrated, the windows 28, 30 may be generally rectangular, but are not limited thereto. The upper edge 22 of the base section 12 defines a hinged-junction 32 to flap 14, where flap 14 is foldable at the hinged-junction 32 to become superimposed over a portion of the base section 12.

Raw slices of animal protein, which in an exemplary embodiment are in the form of bacon or other meat (not shown), can be placed lengthwise in a shingled relationship to each other across the width dimension on the base section 12 of the bacon board 10, whereupon flap 14 is pivoted or folded into an overlying relationship above the uppermost or topmost bacon strip or strips as viewed in FIG. 1. In this configuration, the bacon and bacon board 10 are then placed within a sealed enclosing container, using equipment such as a vacuum packaging machine (not shown), in which the bacon board and bacon slices are vacuum sealed within a clear film to form a tightly conforming package ready for ultimate sale to the consumer. This is just one example of a use of the disclosed packaging material. Other exemplary embodiments may be used to package food products in the form of other types of animal protein, fruit, vegetables, legumes, or high fat-containing or high moisture-containing foods, placed on the disclosed packaging material as a single item or as multiple items in side-by-side, stacked, or shingled orientations.

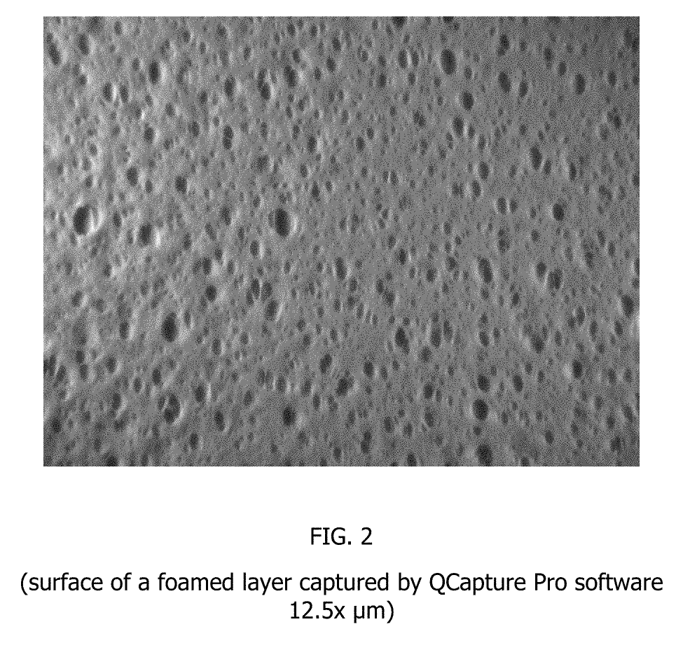

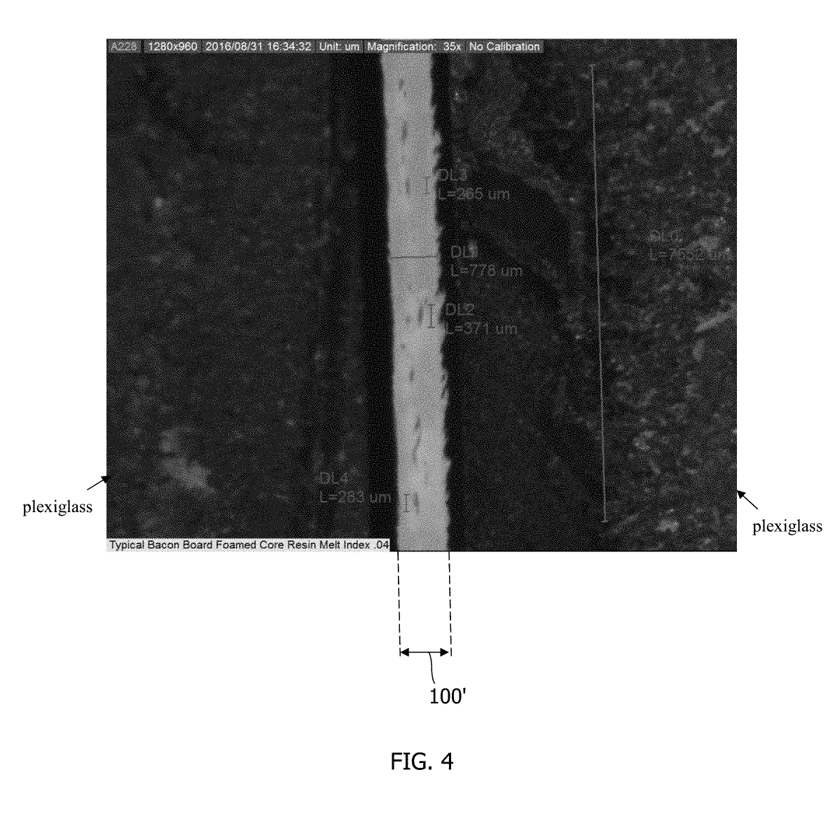

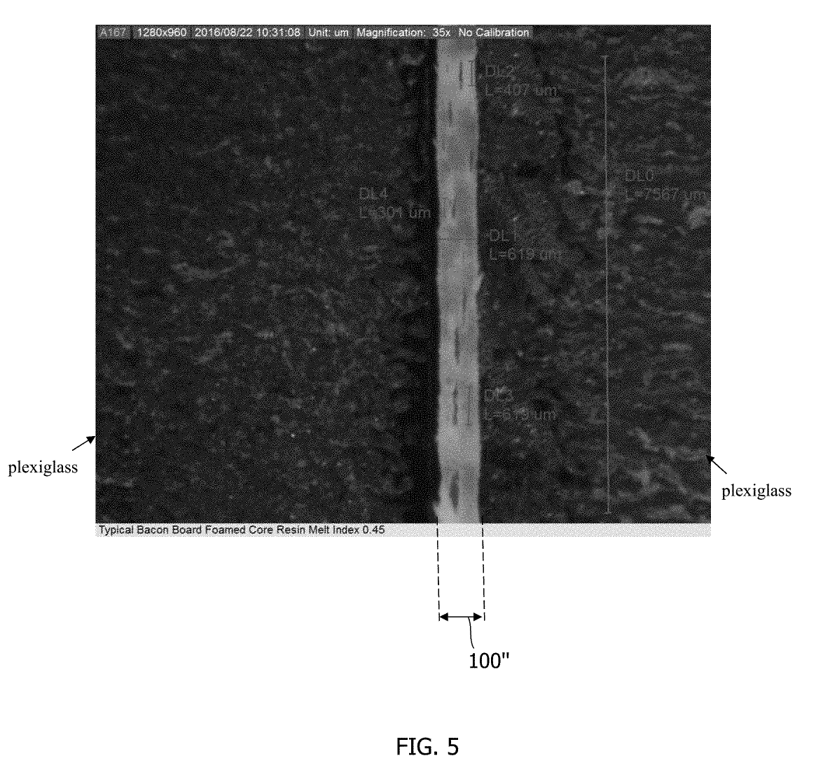

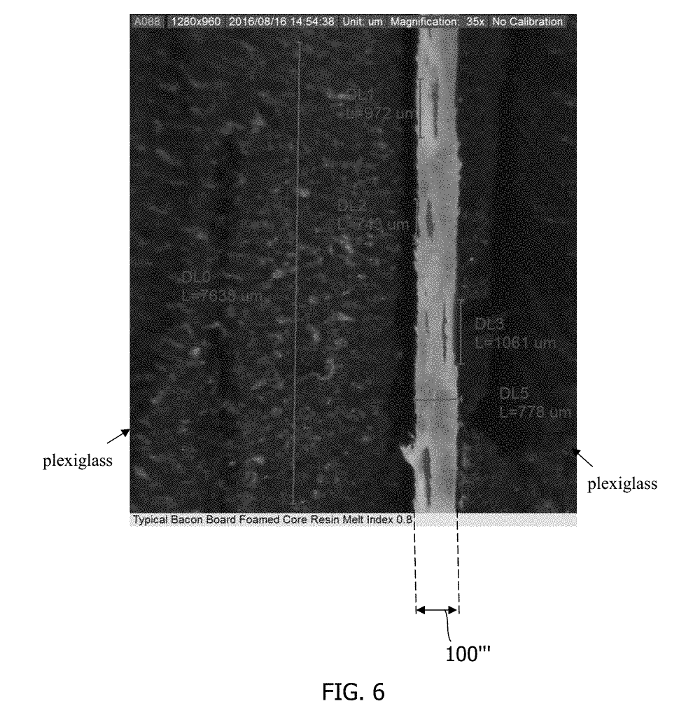

The bacon board 10, which may take other shapes suitable for the food product to be placed thereon and packaged, may be made of the packaging materials 100, 100′, 100″, and 100″′ shown in FIGS. 2-6. Packaging materials 100, 100′, 100″, 100″′, and 100″″ have an non-foamed layer 106 and a foamed layer 104 that are a coextruded blown film. The foamed layer 104 can include a polyethylene (e.g., a high density polyethylene, a low density polyethylene, or both), another suitable polymer copolymer or polymer blend, and combinations thereof, as well as filler particles. The filler particles can be about 40% to about 80% by weight (wt. %) of the foamed layer 104. The foamed layer 104 can have cavitated cells (also referred to as micro-voids) proximate filler particles, foamed cells, or both.

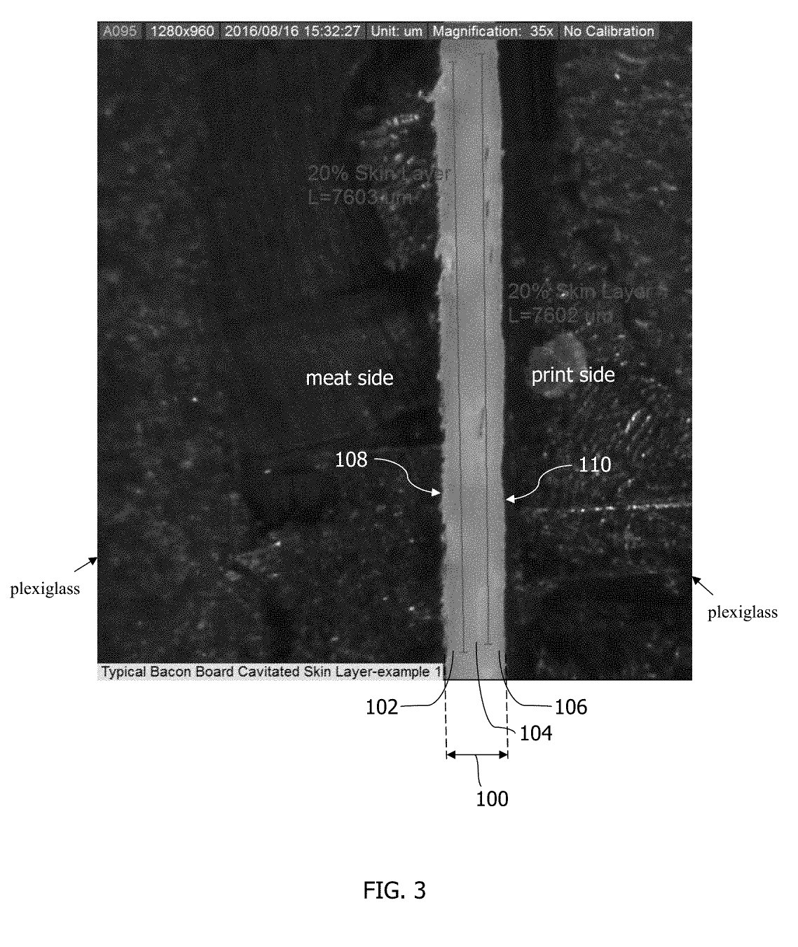

As used herein, “cell size” means the cross-sectional length of a visible cell within a transverse cross-section length of a sample. Exemplary cross-sections are shown in the SEM images of FIGS. 3-6.

As used herein, “foamed cells” are open cells defined in a foamed layer (e.g., foamed layer 104) as a result of the presence of a foaming agent, which often includes voids in the exterior surface of the foamed layer as shown in FIG. 2. In the working examples disclosed herein, the foamed cells had a cell size of about 70 μm to about 1100 μm, with an average cell size of about 200 μm to about 600 μm, depending upon the resin selected for the foamed layer.

As used herein, “cavitated cells” are open cells defined within any layer of a film that surround or are adjacent to filler particles, singly or in groups or clusters, which can be well dispersed in the layer. Cavitated cells are generally internal to each layer and typically do not open to an exterior surface thereof. Further, cavitated cells can be smaller than the foamed cells. For example, cavitated cells can be about 1.3 to about 3.4 times smaller (e.g. about 75% to about 30% smaller), based on the average cell size present in a length of bacon board, depending upon the resin selected for the foamed layer.

As used herein, the term “about” allows for a degree of variability in a value or range, for example, within 10%, within 5%, or within 1% of a stated value or of a stated limit of a range.

Further provided herein are packaging materials, such as packaging materials that include a non-foamed layer and a foamed layer. The non-foamed layer and the foamed layer are a coextruded blown film. The foamed layer includes a polyethylene, filler particles, and foamed cells. The polyethylene is present in an amount of about 20 wt. % to about 100 wt. % of the foamed layer. The filler particles are present in an amount of about 0 wt. % to about 80% wt. % of the foamed layer.

The packaging material can include more than one foamed layer. For example, the packaging material can include two foamed layers and a non-foamed layer. FIGS. 3-6 show exemplary embodiments of packaging materials 100, 100′, 100″, and 100″′ that include two foamed layers and a non-foamed layer. Foamed layer 104 serves as the core layer and foamed layer 102 serves as a skin layer. Layer 106 is a non-foamed layer and can serve a printable layer.

A printable layer is one that has an exterior surface that is a satisfactory printing surface that yields commercial print quality using known and hereinafter developed printing methods, such as, but not limited to, flexography, photogravure, offset flexography, rotogravure, and digital printing.

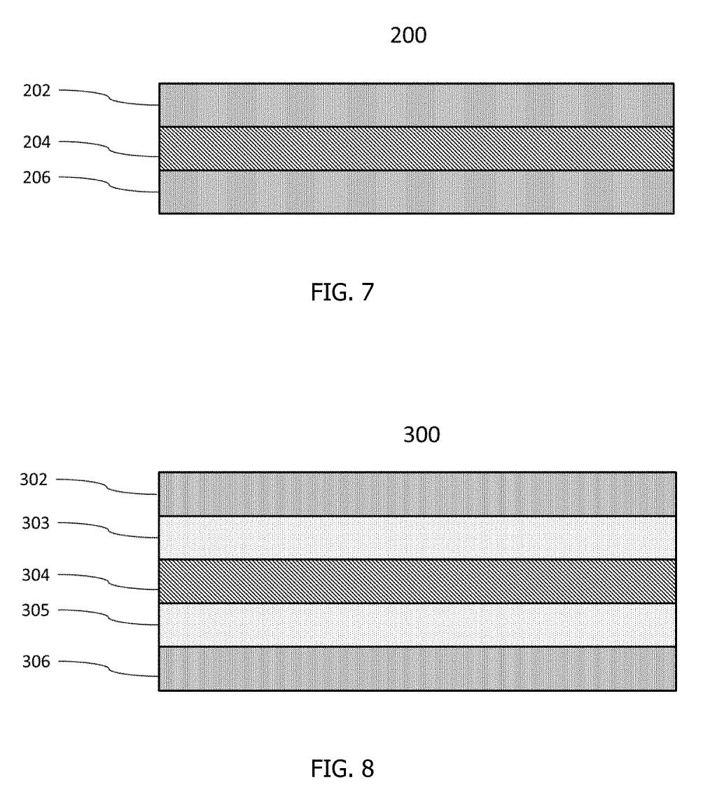

The packaging material can include more than one non-foamed layer. For example, the packaging material can include two non-foamed layers and a foamed layer. FIG. 7 shows an exemplary embodiment of a packaging material 200 that includes two non-foamed layers 202 and 206 and foamed layer 204. Foamed layer 204 serves as the core layer. Non-foamed layer 202 is located on one side of the foamed core layer and non-foamed layer 206 is located on the other side of the foamed core layer. Non-foamed layers 202 and 206 can be printable layers. Although not illustrated, a packaging material having three layers can also have two non-foamed layers located on the same side of a foamed layer.

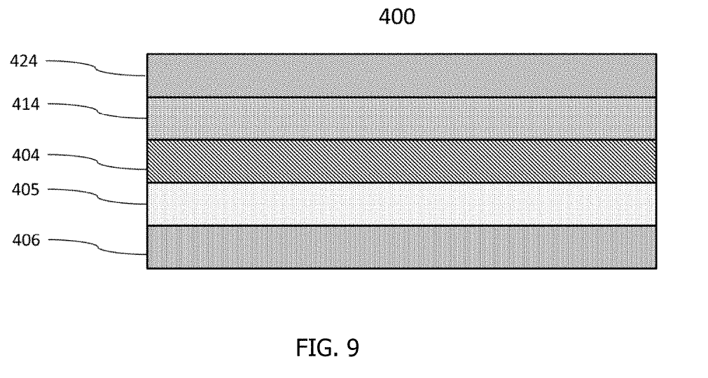

In some embodiments, the packaging material can include five layers. For example, the packaging material can include four non-foamed layers and a foamed layer. FIG. 8 shows an exemplary embodiment of a packaging material 300 that includes five layers. Packaging material 300 includes a foamed core layer 304 and four non-foamed layers including two non-foamed layers 302 and 303 on one side of the foamed core layer and two non-foamed layers 305 and 306 on the other side of the foamed core layer. The outer non-foamed layers 302 and 306 can be printable layers.

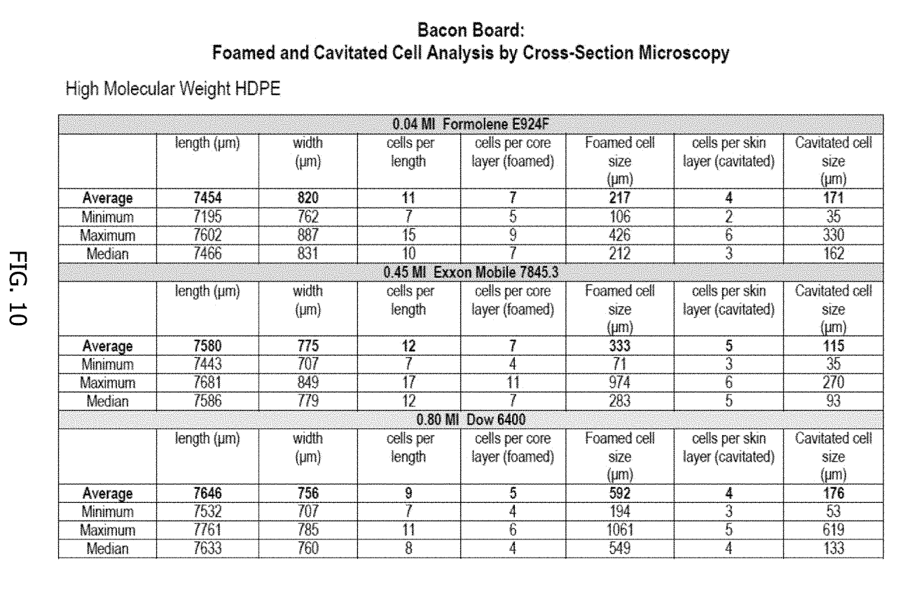

The packaging material can also include more than one foamed layer. For example, the packaging material can include two non-foamed layers and three foamed layers. FIG. 9 shows an exemplary embodiment of a packaging material 400 that includes five layers, three of which are foamed. Packaging material 400 includes a foamed core layer 404 and two additional foamed layers including intermediate foamed layer 414 and outer foamed layer 424 on one side of the foamed core layer 404. Packaging material 400 also includes two non-foamed layers including intermediate non-foamed layer 405 and outer non-foamed layer 406 on the other side of the foamed core layer 404. Outer non-foamed layer 406 can be a printable layer.

The foamed layer of the packaging materials disclosed herein can also include cavitated cells in addition to foamed cells.

In some embodiments, the polyethylene of the foamed layer is a high density polyethylene. The foamed layer can include about 20 wt. % to about 60% wt. %, about 30 wt. % to about 55 wt. %, or about 40 wt. % to about 50 wt. % of a high density polyethylene.

As used herein, “high density polyethylene” refers to a polyethylene having a density from about 0.94 to about 0.97 g/cm³.

The high density polyethylene can have a molecular weight of at least about 200,000 g/mol. In some embodiments, the high density polyethylene in the foamed layer has a weight average molecular weight (M_{w}) of about 500,000 g/mol to about 3,000,000 g/mol or about 750,000 g/mol to about 2,000,000 g/mol. In some embodiments, the high density polyethylene in the foamed layer has a number average molecular weight (Mₙ)of about 500,000 g/mol to about 3,000,000 g/mol or about 750,000 g/mol to about 2,000,000 g/mol. Another characteristic of the high density polyethylene is its melt index, which is often considered in combination with the density and the molecular weight.

The melt index of the high density polyethylene can be about 0.01 g/10 min to about 1 g/10 min. In some embodiments, the melt index of the high density polyethylene can be about 0.02 g/10 min to about 0.8 g/10 min or about 0.04 g/10 min to about 0.5 g/10 min. For example, the melt index of the high density polyethylene can be about 0.3 g/10 min to about 0.6 g/10 min or about 0.4 g/10 min to about 0.5 g/10 min, such as about 0.45 g/10 min. In some embodiments, the melt index of the high density polyethylene can be about 0.6 g/10 min to about 1.0 g/10 min or about 0.7 g/10 min to about 0.9 g/10 min, such as about 0.8 g/10 min. The melt index is measured according to ASTM D-1238-90b, and the density of polyethylene is measured according to ASTM D-1505-85. Mixtures or blends of high density polyethylene, with or without other polymer materials, for example, medium or low density polyethylene or polypropylene, may be used in the foamed layer or the non-foamed layer.

As used herein, the term “low density polyethylene” refers to a polyethylene having a density from about 0.90 to about 0. 926 g/cm³.

As used herein, the term “medium density polyethylene” refers to a polyethylene having a density from about 0.926 to about 0.94 g/cm³.

The polyethylene of the foamed layer can also be a low density polyethylene. In some embodiments the low density polyethylene has a melt index of about 0.1 g/10 min to about 2.0 g/10 min. For example, the low density polyethylene can have a melt index of about 0.2 g/10 min to about 1.0 g/10 min, about 0.2 g/10 min to about 0.8 g/10 min, or about 0.3 g/10 min to about 0.5 g/10 min. In some embodiments, the low density polyethylene can have a melt index of about 0.4 g/10 min.

The low density polyethylene can have a weight average molecular weight (M_{w}) of about 150,000 g/mol to about 400,000 g/mol. For example, the low density polyethylene can have a M_{w} of about 160,000 g/mol to about 400,000 g/mol and a melt index of about 0.2 g/10 min to 1.0 g/10 min, about 200,000 g/mol to 400,000 g/mol and a melt index of about 0.2 to 0.7, or a combination thereof.

The low density polyethylene has a density of about 0.90 g/cm³ to about 0.926 g/cm³. In some embodiments, the low density polyethylene has a density of about 0.90 g/cm³ to about 0.91 g/cm³ or about 0.91 g/cm³ to about 0.926 g/cm³. For example, the low density polyethylene can be MARLEX® 5628 low density polyethylene, which has a density of 0.922 g/cm³.

In some embodiments, the low density polyethylene includes at least one low density selected from MARLEX® 5628, Westlake EF606AA, or a combination thereof.

The low density polyethylene can be present in an amount of about 20 wt. % to about 100 wt. % of the foamed layer. For example, the low density polyethylene can be present in an amount of about 40 wt. % to about 95 wt. %, about 50 wt. % to about 90 wt. %, or about 65 wt. % to about 85 wt. % of the foamed layer. In some embodiments, the foamed layer includes about 70 wt. % to about 80 wt. % of a low density polyethylene. For example, the foamed layer can include about 70 wt. %, about 75 wt. %, or about 80 wt. % of a low density polyethylene.

In some embodiments, the foamed layer includes about 10 wt. % to about 40 wt. % of the filler particles. For example, the foamed layer can include about 15 wt. % to about 35 wt. % or about 20 wt. % to about 30 wt. % of the filler particles. In some embodiments, the foamed layer includes about 20 wt. %, 25 wt. % or about 30 wt. % of the filler particles.

In some embodiments, the foamed layer includes about 40 wt. % to about 80 wt. %, about 45 wt. % to about 70 wt. %, or about 50% to about 60% wt. % of the filler particles. The weight ratio of the filler particles to the polyethylene (e.g., high density polyethylene) can be at least about 0.7, at least about 0.8, or at least about 0.9, e.g., about 1.0, 1.2 or 1.5.

The filler particles can have a mean particle size of about 0.05 μm to about 10 μm. For example the filler particles can have a mean particle size of about 0.1 μm to about 5 μm.

The filler particles of the foamed layer can be provided to an extrusion process in several forms. These forms may be fed to the feed throat of a plasticating extruder feeding one or more layers of a film die used to prepare a coextruded film. These forms may be fed alone or in combination with one or more types of polymer pellets, which may or may not contain other components, such as additives, processing aids, chemical blowing agents or other suitable materials. Conventional compounding, in which fillers are dispersed at high concentration into a carrier polymeric resin matrix (e.g., the same or similar resin as the resin used for an individual layer of a coextruded film) and formed into pellets may be used. Pellets of such compounds may contain at least the weight rate ratio of filler particles to polymer as described in various embodiments of this disclosure. In some embodiments, agglomerates of filler particles having a mean agglomerate size of about 50 μm to about 6,000 μm may be prepared and fed to the feed throat of the extruder in combination with resin pellets, which may or may not contain other components as described above. These filler agglomerates are designed to be handled and fed to the extruder throat using conventional resin conveying and feeding/blending equipment and are designed to readily de-agglomerate into the individual filler particles from which they were prepared and disperse uniformly into the polymer being processed in the extruder. In some embodiments, the filler agglomerates have a mean size of about 50 μm to about 400 μm. In some embodiments, the filler agglomerates have a mean size of about 3,000 μm to about 6,000 μm. For example, the filler agglomerates can have a mean size of about 4,000 μm to about 5,000 μm. In some embodiments, specialized commercially available equipment may be used to directly feed filler particles to the extruder feed throat in combination with one or more types of polymer pellets, which generally would contain other components of the types described above. In this case, no compounding or agglomeration process step to prepare the filler particles for feeding to the extruder may need to be employed.

As used herein, the term “aspect ratio” refers to the ratio of particle length to particle thickness. For any given filler, the aspect ratio is the average value determined for a representative number of particles by examination through a microscope. The length is the longest dimension, measured through the center of mass of the particle. Once the length is known, it is possible to measure the dimensions of the particle in two other directions perpendicular to each other and perpendicular to the length. These two dimensions are referred to as the width and thickness of the particle, with the thickness being the smaller of the two when they are not equal. The filler particles in the foamed layer can have an aspect ratio of 1 to about 3, 1 to about 2, or 1 to about 1.5. Fillers with low aspect ratios, i.e., tending to be a ratio of 1.0, to about 1.5, although irregular, are often described as spherical, round, or cubic. Suitable filler particles include alkali metal or alkaline earth metal carbonates, sulfates and phosphates, and mixtures thereof. Examples include calcium carbonate, sodium carbonate, barium sulfate, calcium sulfate, sodium sulfate, sodium phosphate, potassium phosphate, and calcium phosphate. Other suitable filler particles include but are not limited to talc, mica, wood flour, modified starch, and combinations thereof, which may also be present in combination with one or more of an alkali metal or alkaline earth metal carbonate, sulfate and phosphate.

The filler agglomerate can include a “surface treated compacted material” as described in U.S. Published Application 2012/0095136, the entire contents of which are incorporated herein by reference, resulting from the method of manufacture disclosed therein, and characterized as a material that is completely re-dispersible in a thermoplastic polymer matrix without any compounding step. For instance, when a surface treated compacted material, such as a calcium carbonate of this type, is used, this type of filler or agglomerated filler particles can be fed directly into the feed throat of a blown film extruder at the same time as a stream of resin as a continuous manufacturing process, without a compounding step. “Completely re-dispersible” means dispersions, which are visually tested on pressed film under a binocular magnifier with magnification of 50 of each of the dispersions made, that show no black spots corresponding to the matrix polymer nor white spots corresponding to the primary powders. A suitable surface treated compacted material for a foamed layer in the packaging material is a calcium carbonate surface treated with an ethylene copolymer, a stearic acid, zinc oxide, synthetic paraffin wax, polyethylene metallocene wax, propylene wax, or a combination thereof. In some embodiments, the surface treatment is a blend of an ethylene copolymer and a propylene wax. The calcium carbonate can be natural ground calcium carbonate present in the material as about 75% to about 98% by weight thereof, or from about 86% to about 92% by weight. These materials can have a mean agglomerate size of about 50 μm to about 400 μm, more preferably about 100 μm to about 400 μm, and are characterized as “free-flowing” as evaluated by the DIN-53492 standard. Suitable surface treated compacted materials are available from OMYA International under the brand name OMYA TP 12753-ZP, for example.

Commercially available equipment, such as volumetric or gravimetric feeders, may be used to feed the filler, agglomerated filler particles, filler particles, or a combination thereof into the extruder(s) of a blown film line, and companies like Coperion K-Tron of Sewell, N.J. can assist in determining an effective setup of equipment for the selected compounded filler. filler agglomerate, filler particles, or combination thereof.

In the foamed layer, the filler particles can promote the formation of foamed cells. In the non-foamed layer, the filler particles, as a result of the extrusion and film blowing process, can produce cavitated cells.

In the foamed layer, a foaming agent can be used to produce foamed cells in the polyethylene. The foaming agent can be a chemical foaming agent, a supercritical fluid, or a combination thereof.

A chemical foaming agent is a material added into the polyethylene that, subsequent to introduction in the polymer, will undergo a degradation reaction under selected processing conditions to produce a gas. Example chemical foaming agents include azo-based compounds, carbonate-based compounds, and hydrazide-based compounds. Some specific examples include azodicarbonamide, azodiisobutyronitrile, benzenesulfonhydrazide, 4,4-oxybenzene sulfonyl-semicarbazide, p-toluene sulfonyl semicarbazide, barium azodicarboxylate, N,N′-dimethyl-N,N′-dinitrosoterephthalamide, trihydrazino triazine, and preparations of carbonate compounds and polycarbonic acids. These compounds can be used individually or in combination with one another. Further, such compounds typically decompose to liberate gas, such as N₂, CO₂, and/or H₂O (steam) during the blown film process. In some embodiments, the chemical foaming agent is an endothermic chemical foaming agent such as XO-256 from Bergen International.

In some embodiments, the chemical foaming agent can be about 0.1 wt. % to about 4 5 wt. % of the foamed layer prior to extrusion. For example, the chemical foaming agent can be about 0.5 wt. % to about 2 wt. % of the foamed layer prior to extrusion or about 0.75 wt. % to about 1 wt. % the foamed layer prior to extrusion, or in an amount that reduces the density of the end film to a value in the range of about 5% to about 30%. In some embodiments, prior to extrusion, the foamed layer includes about 0.5 wt. % to about 4 wt. % or about 1.5 wt. % to about 3 wt. % of an endothermic chemical foaming agent.

The foaming agent can also be a supercritical fluid. When employed as the foaming agent, a supercritical fluid is typically introduced directly into the polymer at a selected phase of the manufacturing process where the temperature and pressure are controlled, so that foaming does not occur until the temperature, pressure, or both is changed to a condition that allows foaming to occur as desired. Supercritical fluids can possess liquid-like densities, gas-like viscosities, and diffusivities intermediate to that of a liquid and a gas. Example supercritical fluids include carbon dioxide and nitrogen. In a blown film extrusion process, as discussed below in more detail, the supercritical fluid is typically introduced into the extruder containing the polymer resin in the molten state, which is upstream of the extrusion die that forms a tubular film of polymer in a semimolten state. The tubular film is then blown to stretch the film. During the flow of the polymer through the extrusion die and film blowing step, its temperature and pressure are reduced, the supercritical fluid drops below its critical point, becomes a gas and can create foamed cells in the polymer resin.

The supercritical fluid can be introduced into the extruder at a rate that results in the supercritical fluid being present at a concentration of about 0.08 wt. % to about 0.46 wt. % of the foamed layer or about 0.21 wt. % to about 0.23 wt. % of the foamed layer prior to foaming, or in an amount that reduces the density of the end film to a value in the range of about 5% to about 30%. In some embodiments, the supercritical fluid is introduced into the extruder at a rate that results in the supercritical fluid being present at a concentration of about 0.01 wt. % to about 0.5 wt. % of the foamed layer or about 0.02 wt. % to about 0.03 wt. % of the foamed layer prior to foaming. For example, the supercritical fluid can be introduced into the extruder at a rate that results in the supercritical fluid being present at a concentration of about 0.023 wt. % of the foamed layer.

When a supercritical fluid of nitrogen is used as the foaming agent, the newly formed foamed cells of the foamed layer can include about 80% to about 100% nitrogen by volume, about 90 to 100% nitrogen by volume, or about 95% to 100% nitrogen by volume.

The foamed layer shown in FIG. 2 and represented as layer 104 in FIG. 3, as a result of the presence of the cavitated cells and foamed cells, has a reduced density, which increases the thickness of the packaging material during manufacturing. Also, the presence of the foamed cells contributes a surface roughness (see, for example, the open cavities in the surface of the foamed layer in FIG. 2) to a surface 108 of the coextruded blown film 100 of FIG. 3 (i.e., the packaging material) upon which the meat will be placed, thereby helping to hold the meat in place during the packaging process. In some embodiments, the foamed layer contributes a surface roughness to a surface of the coextruded blown film upon which bacon or other meat is seated of about 1 to about 7 Sa μm measured using a 3D optical surface profiler. Sa is a parameter used to evaluate surface roughness and is an extension of Ra (arithmetical mean height of a line) to a surface and it expresses, as an absolute value, the difference in height of each point compared to the arithmetical mean of the surface. The surface 108, the meat side of the bacon board, is preferably the inside layer of the tubular film during the blowing process, which stays at a higher temperature over an extended period of time. The opposing surface 110 of the coextruded blown film, the print side of the bacon board, is preferably the outside layer of the tubular film during the blowing process.

In some embodiments, the foamed layer includes about 70 wt. % to about 80 wt. % of a low density polyethylene having a melt index of about 0.35 g/10 min to about 0.45 g/10 min (e.g. about 0.40 g/10 min) and about 20 wt. % to about 30 wt. % calcium carbonate filler particles. The calcium carbonate can have a mean particle size of about 0.05 μm to about 10 μm. The foamed cells can be formed by introducing nitrogen as a supercritical fluid into the extruder at a concentration of about 0.21 wt. % to about 0.23 wt. % of the foamed layer.

The non-foamed layer of the packaging material can include a high density polyethylene. The high density polyethylene can have a melt index of about 0.01 g/10 min to about 1 g/10 min, about 0.02 g/10 min to about 0.8 g/10 min, or 0.04 g/10 min to about 0.5 g/10 min. In some embodiments, the melt index of the high density polyethylene can be about 0.3 g/10 min to about 0.6 g/10 min or about 0.4 g/10 min to about 0.5 g/10 min. For example, the melt index of the high density polyethylene can be about 0.4 g/10 min, about 0.45 g/10 min, or about 0.5 g/10 min. For instance, the high density polyethylene can be LyondellBasell Alathon L5845, which has a melt index of about 0.45 g/min. In some embodiments, the melt index of the high density polyethylene can be about 0.6 g/10 min to about 1.0 g/10 min or about 0.7 g/10 min to about 0.9 g/10 min, such as about 0.8 g/10 min. Other examples of high density polyethylene suitable for use in the non-foamed layer include FORMOSA PLASTICS® FORMOLENE® E924F (melt index 0.04), EXXONMOBIL™ HDPE HD 7845.30 (melt index 0.45 g/10 min), EXXONMOBIL™ HDPE HD 7960.13 (0.06 g/10 min), and DOW® NIVAL™ DMDH-6400 (melt index 0.80 g/10 min).

The non-foamed layer can include about 10 wt. % to about 90 wt. % of a high density polyethylene. For example, the non-foamed layer can include about 15 wt. % to about 75 wt. %, about 20 wt. % to about 60 wt. %, or about 30 wt. % to about 50 wt. % of a high density polyethylene. In some embodiments, the non-foamed layer includes about 35 wt. % to about 45 wt. % of a high density polyethylene, such as about 40 wt. % of a high density polyethylene.

The non-foamed layer can also include filler particles. Suitable filler particles include alkali metal or alkaline earth metal carbonates, sulfates and phosphates, and mixtures thereof. Examples include calcium carbonate, sodium carbonate, barium sulfate, calcium sulfate, sodium sulfate, sodium phosphate, potassium phosphate, and calcium phosphate. Other suitable filler particles include but are not limited to talc, mica, wood flour, modified starch, and combinations thereof, which may also be present in combination with one or more of an alkali metal or alkaline earth metal carbonate, sulfate and phosphate. In some embodiments, the filler particles of the non-foamed layer include a calcium carbonate.

The filler particles of the non-foamed layer can have a mean particle size of about 0.05 μm to about 10 μm. For example, the filler particles can have a mean particle size of about 0.1 μm to about 5 μm.

The filler particles of the non-foamed layer can be provided to an extrusion process in several forms. These forms may be fed to the feed throat of a plasticating extruder feeding one or more layers of a film die used to prepare a coextruded film. These forms may be fed alone or in combination with one or more types of polymer pellets, which may or may not contain other components, such as additives, processing aids, chemical blowing agents or other suitable materials. Conventional compounding, in which fillers are dispersed at high concentration into a carrier polymeric resin matrix (e.g., the same or similar resin as the resin used for an individual layer of a coextruded film) and formed into pellets may be used. Pellets of such compounds may contain at least the weight rate ratio of filler particles to polymer as described in various embodiments of this disclosure. In some embodiments agglomerates of filler particles having a mean agglomerate size of about 50 μm to about 6,000 μm may be prepared and fed to the feed throat of the extruder in combination with resin pellets which may or may not contain other components as described above. These filler agglomerates are designed to be handled and fed to the extruder throat using conventional resin conveying and feeding/blending equipment and are designed to readily de-agglomerate into the individual filler particles from which they were prepared and disperse uniformly into the polymer being processed in the extruder. In some embodiments the filler agglomerates have a mean size of about 50 μm to about 400 μm. In some embodiments, the filler agglomerates have a mean size of about 3,000 μm to about 6,000 μm. For example, the filler agglomerates can have a mean size of about 4,000 μm to about 5,000 μm. In some embodiments, specialized commercially available equipment may be used to directly feed filler particles to the extruder feed throat in combination with one or more types of polymer pellets, which generally would contain other components of the types described above. In this case, no compounding or agglomeration process step to prepare the filler particles for feeding to the extruder may need to be employed.

The non-foamed layer of the packaging material can include about 40 wt. % to about 80 wt. % filler particles. In some embodiments, the non-foamed layer includes about 50 wt. % to about 70 wt. % or about 55 wt. % to about 65 wt. % filler particles. For example, the non-foamed layer can include about 55 wt. %, about 60 wt. %, or about 65 wt. % filler particles.

In some embodiments, the non-foamed layer of the packaging material includes about 40 wt. % to about 80 wt. % calcium carbonate as the filler particles. For example, the non-foamed layer can include about 50 wt. % to about 70 wt. % or about 55 wt. % to about 65 wt. % calcium carbonate as the filler particles. In some instances, the non-foamed layer includes about 55 wt. %, about 60 wt. %, or about 65 wt. % of calcium carbonate as the filler particles.

In some embodiments, the non-foamed layer includes about 50 wt. % to about 70 wt. % calcium carbonate and about 30 wt. % to about 50 wt. % high density polyethylene.

As disclosed herein, both the non-foamed and foamed layers can include filler particles. In some embodiments, the filler particles are about 40 wt. % to about 80 wt. % of the packaging material. For example, the packaging material can include about 40 wt. % to about 70 wt. % filler particles, about 40 wt. % to about 60 wt. %, about 40 wt. % to about 50 wt. %, or about 40 wt. % to about 45 wt. % filler particles. In some embodiments, the packaging material includes about 40 wt. % to about 70 wt. % calcium carbonate filler particles, about 40 wt. % to about 60 wt. %, about 40 wt. % to about 50 wt. %, or about 40 wt. % to about 55 wt. % calcium carbonate filler particles.

As discussed above, the coextruded blown film can include one or more foamed layers. In a three-layer extruded blown film, as shown in FIGS. 3-6, two of the layers are foamed layers, core layer 104 and skin layer 102. In some embodiments, just the core layer 104 may be foamed, or just the skin layer 102 may be foamed. For skin layer 102 to be printable, it should be substantially free of foamed cells, even though it has cavitated cells. The three-layer coextruded blown film is represented as being an A/B/C structure, with A being the meat side and C being the print side of the bacon board. In some embodiments, the skin layers A and C are present in equal thickness, each being about 10% to about 25% of the total film thickness, more preferably each being about 15% to about 20% of the total film thickness. The three-layer coextruded blown film of FIG. 3 has an A/B/C structure with percent thicknesses of 20/60/20. In some embodiments, the percent thicknesses are 17/66/17. In some embodiments, where A is the only foamed layer, the percent thickness of A will be greater than B and C, with the B and C layers each having a thickness similar to those set forth above for the skin layers. For example, the percent thicknesses may be 66/17/17 or 60/20/20. In these examples, the two thinnest layers have the same thickness, but that is not required.

The packaging materials describe herein can have more than three layers, as long as the equipment can successfully process the polymers chosen for performance and economic considerations. At least one of the layers is a foamed layer. In some embodiments, two or more foamed layers may be present, as represented by the letter “F” in Table 1 below as illustrated for up to 5 layers in the multilayer, coextruded blown film packaging material. Analogous arrangements of foamed layers are anticipated for multilayer, coextruded blown films containing different numbers of layers.

TABLE 1
Meat Surface → Print Surface

| Ex. | A | B | C | D | E |
|---|---|---|---|---|---|
| 1 | F | | | | |
| 2 | F | F | | | |
| 3 | F | F | F | | |
| 4 | | F | | | |
| 5 | | F | F | | |
| 6 | | | F | | |

Generally, as designated above in Table 1, layer A is the meat side of the packaging material and layer E is the print side. However, Example 6 with the foamed layer as a central core layer may be constructed such that either side (layer A or layer E) is the print side. The layers may be present in different thicknesses as selected to impart advantageous properties to the packaging material, especially making one side of the film a printable layer. Various possible ratios of the thickness for these layers are provided in Table 2.

TABLE 2

| Ex. | A | B | C | D | E |
|---|---|---|---|---|---|
| 1 | 0.1 | 0.1 | 0.6 | 0.1 | 0.1 |
| 2 | 0.1 | 0.1 | 0.5 | 0.15 | 0.15 |
| 3 | 0.15 | 0.15 | 0.4 | 0.15 | 0.15 |
| 4 | 0.1 | 0.1 | 0.4 | 0.2 | 0.2 |
| 5 | 0.12 | 0.12 | 0.32 | 0.22 | 0.22 |
| 6 | 0.12 | 0.12 | 0.26 | 0.25 | 0.25 |

In some embodiments, the foamed layer(s) may include a nucleating agent. Suitable nucleating agents are materials that initiate the formation of a nascent cell; gas diffusion from the polymer matrix surrounding the nucleating site drives cell growth. Uniform distribution and nucleating activity of nucleating agent leads to more uniform distribution of cells, and facilitates more uniform diffusion of the gas in the polymer. A desirable result of a well dispersed nucleating agent is a more uniform distribution of cell size. In one embodiment, the nucleating agent comprises a talc-filled polyolefin, for example, a low density polyethylene with more than 60% talc, such as Multibase Multibatch® ME 50024 talc-filled polyolefin available from Dow Corning.

In some embodiments, the non-foamed layer of the packaging material is a printable material including, for example, high density polyethylene and filler particles, which may be corona treated. Referring to FIG. 3, the non-foamed printable layer is layer 106, which defines a printable surface 110. Typically, the printable surface 110 has a smoothness and/or surface topography that is generally the same as the opposing surface of the film or is smoother than the opposing surface of the film, i.e., surface 108. Suitable high density polyethylene and other polymers are discussed above for the foamed layer and non-foamed layer. Typically, no foaming agent is typically present in the non-foamed layer.

In some embodiments, the non-foamed layer has only cavitated cells (i.e., no foamed cells) in a high density polyethylene including filler particles of the types and in the amounts discussed above. While the non-foamed layer may not include a foaming agent, it may include a nucleating agent. A smoothing coating to improve printability may be applied to the exterior surface of the packaging material (e.g. exterior surface 110). For example, the smoothing coating may be applied using an application unit on a printing press prior to ink application to form graphic images.

In some embodiments, the printable non-foamed layer includes about 40 wt. % to about 80 wt. %, about 45 wt. % to about 70 wt. %, or about 50 wt. % to about 60 wt. % filler particles. The weight ratio of the filler particles to the high density polyethylene can be at least about 0.7, at least about 0.8, or at least about 0.9, e.g., about 1.0, 1.2 or 1.5. In some embodiments, the printable non-foamed layer is 40 wt. % high density polyethylene and 60% wt. % surface treated compacted material made with calcium carbonate, resulting in cavitated cells. This exterior surface of the printable non-foamed layer may be corona or otherwise treated to aid in the printability of the layer.

In all embodiments, each layer of the multilayer, coextruded film may include additives. The additives include, but are not limited to, coupling agents, lubricants, dispersing agents, antistatic agents, antioxidants, processing aids, UV stabilizers, and coloring agents.

The packaging material can have an overall total thickness of about 4 mil to about 20 mil or about 10 mil to about 17 mil. In some embodiments, the packaging material can have an overall total thickness of about 13 mil to about 15 mil. In some embodiments, the packaging material can have an overall total thickness of about 8 mil to about 11 mil. The blown film may be referred to as packaging “board” as a result of its thickness and stiffness.

As used herein, the term “mil” refers to 0.001 inch and 1 mil is equal to about 0.0025 centimeters or about 0.025 millimeters or about 25 micrometers (μm).

In some embodiments, the foamed layer has a thickness of about 0.5 mil to about 10 mil, or about 2 mil to about 6 mil. For example, the foamed layer can have a thickness of about 3 mil to about 4 mil.

In some embodiments, the non-foamed layer has a thickness of about 0.5 mil to about 5 mil, or about 0.75 mil to about 4 mil. For example, the non-foamed layer can have a thickness of about 1 mil to about 2 mil.

The packaging material can have a density of about 0.8 g/cm³ to about 1.5 g/cm³. For example, the packaging material can have a density of about 0.8 g/cm³ to about 0.9 g/cm³, about 0.9 g/cm³ to about 1.0 g/cm³, about 1.0 g/cm³ to about 1.1 g/cm³, about 1.1 g/cm³ to about 1.2 g/cm³, about 1.2 g/cm³ to about 1.3 g/cm³, or about 1.3 g/cm³ to about 1.4 g/cm³, or about 1.4 g/cm³ to about 1.5 g/cm³. The density of the packaging material can be determined as follows: (i) a sample of the packaging material to be tested is obtained by cutting a 10.16 cm by 10.16 cm sample (4 by 4 inch); (ii) the x, y dimensions of the sample are then measured in centimeters to confirm cut dimension accuracy; (iii) the z dimension in three different areas of the sample (sample thickness in inches) is then measured and recorded (in cm) using an automatic micrometer (e.g., a Progage made by Thwing Albert); (iv) the volume of the sample materials is then calculated; (v) the weight of the sample is then obtained on a two place balance and recorded; and (vi) the density of the sample is calculated.

In some embodiments, the packaging material has a density that is about 20% to about 40% less, such as about 25%, 30%, or 35% less, than a packaging material a corresponding packaging material that is not foamed (e.g. no foaming agents are added during extrusion). For example, a packaging material disclosed herein can have a density of about 1.55 g/cm³ before foaming and about 1.09 g/cm³ after foaming.

In some embodiments, the foamed layer contributes a surface roughness to a surface of the coextruded blown film upon which bacon or other meat is seated of about 1 to about 7 Sa μm using a 3D optical surface profiler. For example, the foamed layer contributes a surface roughness to a surface of the coextruded blown film upon which bacon or other meat is seated of about 1 to about 4 Sa μm or about 4 to about 7 Sa using a 3D optical surface profile.

In some embodiments, the ratio of the Taber stiffness in the machine direction (MD) to the Taber stiffness in the cross direction (CD) of the packaging materials can be about 0.8:1.0, about 0.9:1.0, about 1.0:1.0, about 1.1:1.0, or about 1.2:1.0.

Any additional layers besides the non-foamed layer and the foamed layer may be included to provide the packaging material with desired properties, such as increased strength, enhanced barrier properties (particularly if the technique of vacuum skin packaging is used to contain the product), or to separate the foamed layer from the non-foamed layer as an isolating layer to not transmit roughness from the cells in the foamed layer to the surface of the non-foamed layer that could detract from its printability. In some embodiments, the additional layer does not include a filler.

Also provided herein is a packaging material that includes a first outer non-foamed, a first intermediate non-foamed layer, a foamed layer, a second intermediate non-foamed layer, and a second outer non-foamed layer. The first outer non-foamed layer and first intermediate non-foamed layer are on one side of the foamed layer and the second outer non-foamed layer and second intermediate non-foamed layer are on the opposite side of the foamed layer. The first outer non-foamed layer includes a high density polyethylene and calcium carbonate filler particles. The first intermediate non-foamed layer includes a high density polyethylene and calcium carbonate filler particles. The foamed layer includes about 60 wt. % to about 90 wt. % of a low density polyethylene, about 10 wt. % to about 40% wt. % of a calcium carbonate, and foamed cells formed from supercritical nitrogen during extrusion. The second outer non-foamed layer includes a high density polyethylene and calcium carbonate filler particles. The second intermediate non-foamed layer includes a high density polyethylene and calcium carbonate filler particles. The first outer non-foamed layer, the first intermediate non-foamed layer, the foamed layer, the second intermediate non-foamed layer, and the second non-foamed layer are a coextruded blown film.

The high density polyethylene of the first outer non-foamed layer and the first intermediate non-foamed layer can have a melt index of about 0.3 g/10 min to about 1.0 g/10 min and be present in an amount of about 30 wt. % to about 50 wt. %. In some embodiments, the high density polyethylene of the first outer non-foamed layer and the first intermediate non-foamed layer can have a melt index of about 0.3 g/10 min to about 0.5 g/10 or about 0.7 g/10 min to about 0.9 g/10.

The calcium carbonate filler particles of the first outer non-foamed layer and the first intermediate non-foamed layer can be present in an amount of about 40 wt. % to about 70 wt. %. For example, the calcium carbonate filler particles of the first outer non-foamed layer and the first intermediate non-foamed layer can be present in an amount of about 50 wt. % to about 70 wt. %.

The high density polyethylene of the second outer non-foamed layer and the second intermediate non-foamed layer can have a melt index of about 0.3 g/10 min to about 1.0 g/10 min and be present in an amount of about 30 wt. % to about 50 wt. %. In some embodiments, the high density polyethylene of the second outer non-foamed layer and the second intermediate non-foamed layer can have a melt index of about 0.3 g/10 min to about 0.5 g/10 or about 0.7 g/10 min to about 0.9 g/10.

In some embodiments, the foamed layer includes about 70 wt. % to about 80 wt. % of the low density polyethylene and about 20 wt. % to about 30% wt. % of a calcium carbonate.

In some embodiments, the packaging material can have a first outer non-foamed layer that includes 40 wt. % of LyondellBasell Alathon L5845 (a high density polyethylene) and 60 wt. % calcium carbonate filler particles; a first intermediate non-foamed layer that includes 40 wt. % of LyondellBasell Alathon L5845 and 60 wt. % calcium carbonate filler particles; a foamed core layer that includes about 70 wt. % to about 80 wt. % low density polyethylene having a melt index of 0.4 g/10 min, 20 wt. % to about 30 wt. % calcium carbonate filler particles, and foamed cells formed during extrusion from supercritical nitrogen; a second intermediate non-foamed layer that includes 40 wt. % of LyondellBasell Alathon L5845 and 60 wt. % calcium carbonate filler particles; and a second outer non-foamed layer that includes 40 wt. % of LyondellBasell Alathon L5845 and 60 wt. % calcium carbonate filler particles. The ratio of the thickness of the first outer non-foamed layer, the first intermediate non-foamed layer, the foamed layer, the second intermediate non-foamed layer, and the second non-foamed layer (respectively) can be about 0.130:0.130:0.360:0.190:0.190.

Also provided herein is a packaging material that includes an outer foamed layer, an intermediate foamed layer, a foamed core layer, an intermediate non-foamed layer, and an outer non-foamed layer. The outer foamed layer and intermediate foamed layer are on one side of the foamed core layer and intermediate non-foamed layer and outer non-foamed are on the opposite side of the foamed layer. The outer foamed layer includes a high density polyethylene, calcium carbonate filler particles, and foamed cells formed from a foaming agent during extrusion. The intermediate foamed layer includes a high density polyethylene, calcium carbonate filler particles, and foamed cells formed from a foaming agent during extrusion. The foamed core layer includes, about 60 wt. % to about 90 wt. % of a low density polyethylene, about 10 wt. % to about 40 wt. % of a calcium carbonate, and foamed cells formed from a foaming agent during extrusion. The intermediate non-foamed layer includes a high density polyethylene and calcium carbonate filler particles. The outer non-foamed layer includes a high density polyethylene and calcium carbonate filler particles. The outer foamed layer, intermediate foamed layer, foamed core layer, intermediate non-foamed layer, and outer non-foamed layer are a coextruded blown film.

The foaming agent can be a chemical foaming agent, a supercritical fluid, or combinations thereof. For example, the foamed cells of the outer foamed layer and intermediate foamed layer can be formed from a chemical foaming agent, supercritical nitrogen, or a combination thereof during extrusion while the foamed cells of the core layer can be formed from supercritical nitrogen. In some embodiments, the chemical foaming agent for forming the foamed cells in the outer foamed layer and the intermediate foamed layer is an endothermic chemical foaming agent such as XO-256 from Bergen International. The endothermic chemical foaming agent can be about 0.5 wt. % to about 4 wt. % of the foamed layer or about 1.5 wt. % to about 3 wt. % the foamed layer prior to extrusion.

In some embodiments, the foamed cells of the foamed core layer can be formed by introducing a supercritical nitrogen fluid into the extruder in a concentration of about 0.08% to 0.46% by weight of the foamed layer, or about 0.21% to about 0.23% by weight of the foamed layer, or in an amount that reduces the density of the end film to a value in the range of about 5% to about 30%.

The high density polyethylene of the outer foamed layer and the intermediate foamed layer can have a melt index of about 0.3 g/10 min to about 1.0 g/10 min and be present in an amount of about 30 wt. % to about 50 wt. %. For example, the high density polyethylene of the outer foamed layer and the intermediate foamed layer can have a melt index of about 0.3 g/10 min to about 0.5 g/10 or about 0.7 g/10 min to about 0.9 g/10. The calcium carbonate filler particles of the exterior foamed layer and the intermediate foamed layer can be present in an amount of about 50 wt. % to about 70 wt. %.

The high density polyethylene of the outer non-foamed layer and the intermediate non-foamed layer can have a melt index of about 0.3 g/10 min to about 1.0 g/10 min and be present in an amount of about 30 wt. % to about 50 wt. %. In some embodiments, the high density polyethylene of the outer non-foamed layer and the intermediate non-foamed layer can have a melt index of about 0.3 g/10 min to about 0.5 g/10 or about 0.7 g/10 min to about 0.9 g/10.

In some embodiments, the packaging material can have an outer foamed layer that includes 40 wt. % of LyondellBasell Alathon L5845 (a high density polyethylene), 60 wt. % calcium carbonate filler particles, and foamed cells formed from the introduction of 2 wt. % of XO-256 9 (an endothermic chemical foaming agent from Bergen International) during the extrusion process; an intermediate foamed layer that includes 40 wt. % of LyondellBasell Alathon L5845 (a high density polyethylene), 60 wt. % calcium carbonate filler particles, and foamed cells formed from the introduction of 2 wt. % of XO-256 9 during the extrusion process; a foamed core layer that about 70 wt. % low density polyethylene having a melt index of 0.4 g/10 min, about 30 wt. % calcium carbonate filler particles, and foamed cells formed during extrusion from supercritical nitrogen; an intermediate non-foamed layer that includes 40 wt. % of LyondellBasell Alathon L5845 and 60 wt. % calcium carbonate filler particles; and an outer non-foamed layer that includes 40 wt. % of LyondellBasell Alathon L5845 and 60 wt. % calcium carbonate filler particles. The ratio of the thickness of the outer foamed layer, intermediate foamed layer, foamed core layer, intermediate non-foamed layer, and outer non-foamed layer can be about 0.130:0.130:0.360:0.190:0.190.

### Method of Making

The packaging materials can be made by a coextrusion blown film process. For example, the packaging materials can be made via a continuous method of manufacturing, using equipment similar to that disclosed in U.S. Pat. No. 8,889,047, the entire disclosure of which is incorporated herein by reference, but modified to include a means for injecting or adding the supercritical fluid, a chemical foaming agent, or both. The methods for manufacturing such films are not limited to that method, however. For example, the extrusion system used in the continuous method of the '047 patent can be modified to include a blowing agent introduction system as disclosed in U.S. Pat. No. 7,144,532 or U.S. Pat. No. 6,376,059, the entire disclosures of which are incorporated herein by reference, or with other suitable processes and equipment.

Using such a combination of equipment, continuous delivery of a gas, supercritical fluid, and/or chemical foaming agent into the extrusion system is accomplished. The molten extrudate is under pressure at a selected temperature within the extrusion system. While under pressure, growth of the micro-voids can take place producing a self-assembling organized structure thereof. Then, once the pressure is reduced, for example, when the molten extrudate exits the die and before cooling to achieve crystallization, the filler particles and a nucleating agent (if present) further promote nucleation and cell growth, thereby increasing the volume of the film, which decreases the density of the film.

The foamed cells can be formed as a result of the presence of a gas, supercritical fluid, and/or chemical foaming agent. When directly injecting gas or a supercritical fluid into the extruder using the equipment noted above, a flow rate under pressure is selected and controlled for continuous delivery into the extrusion system. The gas or supercritical fluid once injected into the extrudate begins to create an organized structure of bubbles in the liquid polyolefin polymer. When a chemical foaming agent is introduced, gas is produced from a chemical degradation reaction at a selected temperature as the extrudate continues its flow through the extrusion system. After the pressure is reduced, for example, when the molten extrudate exits the die and before cooling to achieve crystallization, further nucleation takes place, thereby changing the volume of the film, which decreases the density of the film and increases thickness of the packaging material.

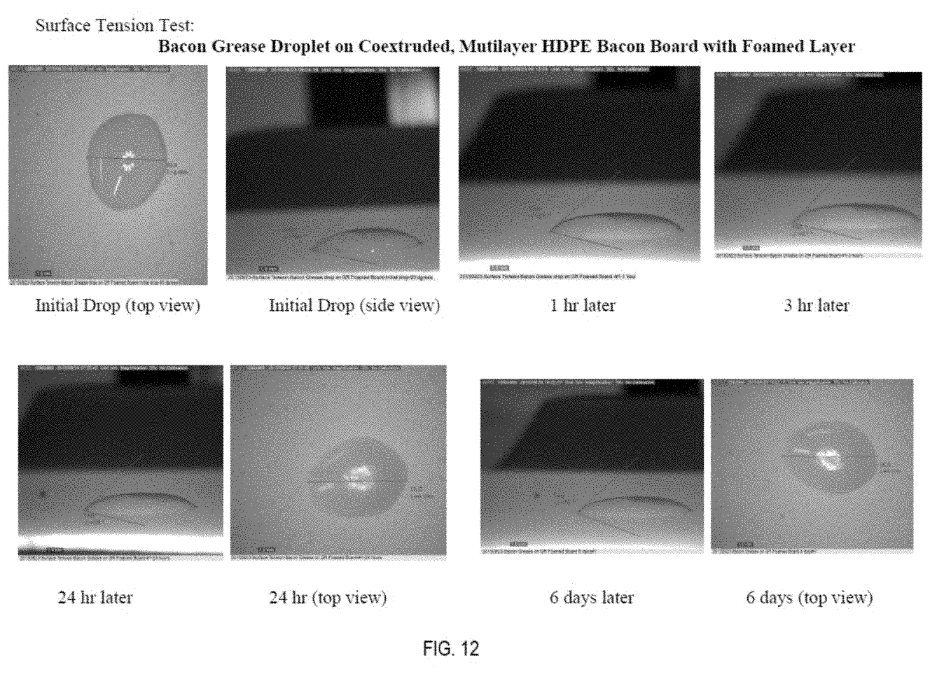

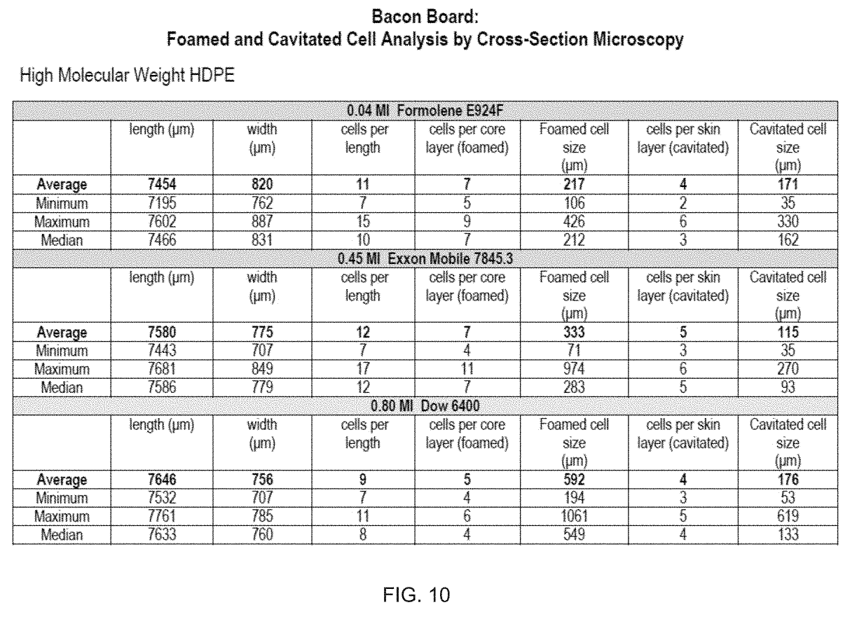

The films that result from the method using the materials disclosed herein have properties suitable for packaging products, such as packaging bacon, other animal protein, or high-moisture or high fat-containing foods. The packaging material, which is an extruded blown film, has a suitable stiffness to support the meat, is foldable, and is cuttable. The packaging material maintains its shape when passing through a printing process, a die-cut process, and through meat processing machinery, such as a shingling process for bacon. The resins used for the extruded blown film, when cut, do not evidence wicking of juices from meat at the cut edges. Moreover, as shown in FIGS. 11-12, the meat receiving surface has surface properties that enable grease or other fats, such as bacon grease, to form beads and remain as beads over a six day period. The coextruded blown film packaging material also is durable to maintain its stiffness property even through refrigerated distribution, after experiencing a freeze-thaw cycle, or both—which is beneficial to the appearance of the packaging and food once a consumer thaws the food. Another advantage that is expected from the coextruded blown film is reduced instances of pinholes in the flexible film portion of the packaging after passing through a vacuum packaging process compared to the wax-coated cellulosic bacon board described in the background herein.

The packaging materials can also be made using a 3 or 5 layer extrusion system, blown film die (e.g., a stacked die), and a web handling system with nip rolls and a winding station. The process also includes a material handling system (e.g., hoppers and feeders) to deliver the desired quantities of resin compound (e.g. a high density polyethylene, low density polyethylene, or both) or additives to the feed throat of the extruders. The extruders can be powered to rotate a single screw carrying the solid material through 4 to 5 temperature zones to melt the solid to a molten like liquid material. The molten material under pressure can flow through a blown film die system (e.g., a stacked die system) with a circumference equal to the diameter of the die. As the material flows through the die opening (gap) it can be cooled and inflated with air handling equipment. The material can be inflated to a desired bubble diameter or layflat and proceed to move vertically through the web handling system and nip rollers. The nip rollers can flatten the bubble into a tube. The flattened tube can proceed through a series of web handling rollers, can be corona treated, and then slit to produce two independent stock rolls.

Filler particles (e.g., calcium carbonate) can be vacuumed from a storage container of filler particles to the hoppers that feed the 3-5 extruders. In addition to the filler particles, using separate hoppers, other material sources such as LDPE can be vacuumed, stored in separate hoppers then metered into the feed throat as a complete replacement or as a percentage of the total material producing a thick film usable for a packaging material (e.g., bacon board) replacement.

Other materials such as foaming agents or nitrogen gas injection (e.g. supercritical nitrogen) can be used to reduce the density of the film. The foaming agents can be added to the material handling system and added to the feed throat similar to any other additive or resin or compound. The nitrogen gas injection system can require a satellite system including of a high pressure system where nitrogen gas is changed to a super critical fluid and injected into the molten material flowing through the extruder to the die.

Working Examples

### Cross-sectional Microscopy Analysis of the Foamed Cells and Cavitated Cells.

FIGS. 3-6 are digital microscope images, at a lens magnification of 35×, of a longitudinal cross-section of bacon board packaging material formed as a blown film of three coextruded layers of high density polyethylene. These images were taken after sandwiching a piece of bacon board between pieces of Plexiglas, which were secured together by clamps, and cutting a cross-section through the bacon board along one side of the Plexiglass using a sharp blade. Nine such samples of each film to be imaged were prepared. Each cut sample, while still between the pieces of Plexiglass, was placed under a microscope lens, a Dino-Lite Capture 2.0 version 1.5.17.B Digital Microscope, at 35× magnification and the image was projected digitally onto a computer screen set at an image resolution of 1280×960 mm (two times screen zoom). Using the computer, the length and the width of the cross-section and the cross-sectional dimensions of each visual cell (foamed or cavitated) were measured and recorded.

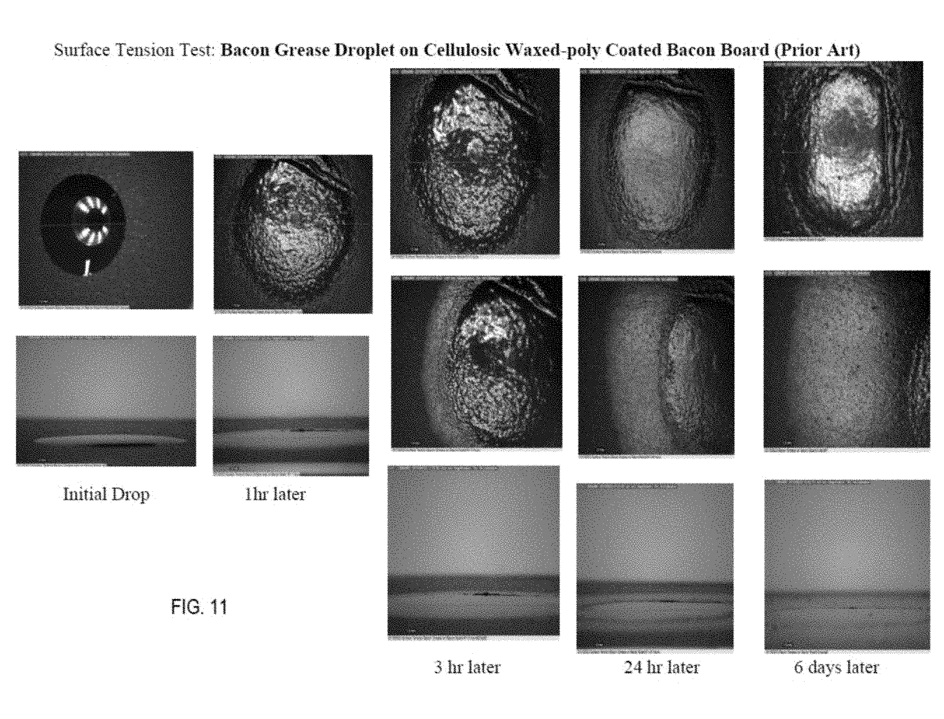

FIG. 10 is a table of the cross-sectional microscopy analysis from the above procedure. The analyzed films are: (1) high molecular weight HDPE, Formolene E924F, melt index 0.04; (2) high molecular weight HDPE, Exxon Mobile 7845.3, melt index 0.45; and (3) high molecular weight HDPE, Dow 6400, melt index 0.8. Interestingly, the average number of cells formed within the cross-section of these films is about 10 (ranged from 9-12), but the melt index of the HDPE affected the size of the foamed cells. In particular, the more viscous the melt or resin matrix, the smaller the cell size of the foamed cell; hence, the resin with the melt index of 0.04 had the smallest foamed cells. It is theorized that a possible explanation is the resin's ability to exhibit a volumetric expansion as the gas induces dilation of the resin—the less viscous the melt, the easier the gas can dilate the resin and, as such, form larger cells.

### Stiffness (Bending Resistance) by the Taber Stiffness Method.

Using AS/NZS 1301.431rp, tester model 150B, a sample of bacon board was bent to a 15° deflection to the left and right direction without using a weight compensator. For a basis for a comparative study, existing cellulosic waxed-poly coated bacon board, “Bacon Board” in Table 2, having a gauge of 10.5 mil and four samples made according to U.S. Pat. No. 8,889,047, GR 40/60 in Table 3, having a gauge 8, 9, 10, and 11, respectively, were tested. The “40/60” for the GR 40/60 blown film is 40% by weight resin, 60% by weight CaCO₃ filler that is not foamed. The test results in the machine direction (MD) and the cross direction (CD) are reported below. As a base line, a sample three layer coextruded blown film made from 100% HDPE (no filler particles) having a melt index of 0.5 g/10 min, gauge of 8 mil was analyzed using the method noted above. The 100% HDPE film had a machine direction of 7 Taber stiffness units and cross direction of 7 Taber stiffness units.

TABLE 3

| | |
|---|---|
| Taber | MilliNewton- |
| Stiffness | meters |
| Units | (mN-M) |

| | Gauge (mil) | MD | CD | MD | CD |
|---|---|---|---|---|---|
| Bacon board | 10.5 | 40 | 19 | 1.86 | 3.92 |
| GR 40/60¹ | 8.0 | 12 | 12 | 1.18 | 1.18 |
| GR 40/60¹ | 9.0 | 19 | 17 | 1.67 | 1.86 |
| GR 40/60¹ | 10.0 | 17 | 16 | 1.57 | 1.67 |
| GR 40/60¹ | 11.0 | 17 | 18 | 1.77 | 1.67 |
| HDPE 100² | 8.0 | 7 | 7 | 0.68 | 0.68 |

Inventive samples were tested using the same method to evaluate the stiffness thereof. The sample films were three layer, coextruded blown films, each made with one of the three HDPE resins identified in FIG. 10. Within each film sample, all three layers included the same HDPE resin, and each layer was loaded with 55-60% CaCO₃. The film's structural thickness was 17/66/17, and the A and B layers were foamed with supercritical nitrogen gas at a rate of 0.02 lbs/hour. Accordingly, the only difference between the three different inventive three layer, coextruded blown films was the HDPE resin used. The test results for the total stiffness are reported in Table 4 below based on the melt index of the HDPE resin.

The machine direction stiffness and the cross direction stiffness for the inventive samples are in a range of 14-19 Taber Stiffness units for a 10 mil film, which while lower than the wax-coated cellulosic bacon board, is still a commercially acceptable range for a meat packaging product. The lower stiffness may even be advantageous—the increased flexibility of the packaging material may reduce or eliminate the formation of pinholes in the outer covering applied to the foods during vacuum packaging. The packaging material also has the other advantages discussed above.

### Grease Bead Test

Three test pieces of existing cellulosic waxed-poly coated bacon board were cut to about a 2″ by 3″ rectangle. Three test pieces of a three layer, coextruded blown film packaging material having the construction disclosed with respect to FIG. 3 were cut to about a 2″ by 3″ rectangle. Bacon grease at a temperature of about 93° F. was prepared. Using an eyedropper, held about a half inch from each test piece, a droplet of bacon grease was dispensed onto each test piece. Each test piece was then placed on a digital microscope platform, and data and a top plan view image of the droplet of bacon grease were captured. Next, a side image of each droplet was captured and data recorded using a computer software. The digital microscope was set to a magnification of 35, measurement unit in mm, and resolution to 1280×960 MJPG.

Three test pieces of existing cellulosic waxed-poly coated bacon board each had an initial droplet size of 5-6 mm for the bacon grease, but the droplet size generally, instantly spread to about 10 mm, so 10 mm is indicated in the table below as the initial drop length. For all droplets at all times the Grade α was 0°, meaning full spreading of the bacon grease on the surface of the existing cellulosic waxed-poly coated bacon board. Grade α refers to the angle of the grease droplet to the surface of the bacon board. The data collected and corresponding to the images in FIG. 11 is presented below in Table 5.

TABLE 5

| | Drop length (mm) at time | | | | | | Grease wetting at the edges of the drop (mm) | | | | | |
|---|---|---|---|---|---|---|---|---|---|---|---|---|
| Trial | initial | 1 hr | 3 hr | 5 hr | 24 hr | 6 days | initial | 1 hr | 3 hr | 5 hr | 24 hr | 6 days |
| 1 | 10 | 11 | 11 | 11 | 11 | 11 | 0 | 0 | 2 | 2 | 4 | 9 |
| 2 | 10 | 11 | 11 | 11 | 11 | 11 | 0 | 0 | 2 | 2 | 4 | 8 |
| 3 | 10 | 11 | 11 | 11 | 11 | 11 | 0 | 0 | 2 | 2 | 4 | 9 |

The bacon grease droplet on all 3 samples spread quickly onto the prior art bacon board. At the first hour, the bacon grease had begun changing to solid, and all microscope measurements went past the 11 mm viewing field of the microscope. The grease solid consistently measured 8 mm from the 3rd to the 24th hour. On day 6, the grease droplet measured 9 mm on all 3 samples. As the grease turned solid, there was a wetting of grease around the solid drop. This wetting measured 2 mm through the 5th hour. At 24 hours, the wetting doubled in size (4 mm). On day 6, the wetting was 9 mm and in one trial went beyond the 11 mm viewing range of the digital microscope.

Three test pieces of the three layer, coextruded blown film packaging material each had an initial droplet size of 4-5 mm for the bacon grease, and the droplet size remained generally consistent at 5 mm over the six day period. The Grade a for all the grease droplets in each trial was <90°, meaning good wetting of the bacon grease on the surface of the three layer, coextruded blown film packaging material. The Grade a ranged from about 54 to about 71 over the entire 6 day period. The data collected and corresponding to the images in FIG. 12 is presented below in Table 6.

TABLE 6

| | Drop length (mm) at time | | | | | | Grade α (degrees) at time | | | | | |
|---|---|---|---|---|---|---|---|---|---|---|---|---|
| Trial | initial | 1 hr | 3 hr | 5 hr | 24 hr | 6 days | initial | 1 hr | 3 hr | 5 hr | 24 hr | 6 days |
| 1 | 5 | 5 | 5 | 5 | 5 | 5 | 60 | 56 | 61 | 62 | 58 | 70 |
| 2 | 4 | 5 | 5 | 5 | 5 | 5 | 63 | 61 | 63 | 64 | 56 | 71 |
| 3 | 5 | 5 | 5 | 5 | 5 | 6 | 55 | 59 | 57 | 54 | 57 | 65 |
| AVE | 4.6 | 5 | 5 | 5 | 5 | 5.3 | 59.3 | 58.7 | 60.3 | 60 | 57 | 68.7 |

For further comparison, a 100% HDPE film having a melt index of 0.5 g/10 min was also tested using the same grease bead test. This film resulted in an increase in drop length over the six day period and a general decrease in Drop α, showing that the surface of the 100% HDPE is different from the inventive films where the beads form and stay over an extended period of time.

Additionally, a 100% PP, monolayer film was tested using the same grease bead test. This film resulted in a small increase in drop length over the six day period and a decrease in Drop α, not as big of a decrease as seen with the 100% HDPE, but still evidencing that the surface of the PP film is different from the inventive films.

It will be appreciated that while the invention has been described in detail and with reference to specific embodiments, numerous modifications and variations are possible without departing from the spirit and scope of the invention as defined by the following claims.

What is claimed is:

1. A packaging material comprising:
a non-foamed layer; and
a foamed layer comprising:
a polyethylene comprising about 20 wt. % to about 100 wt. % of the foamed layer; and
filler particles comprising about 0 wt. % to about 80% wt. % of the foamed layer,
wherein the foamed layer comprises foamed cells and the non-foamed layer and the foamed layer are a coextruded blown film.

2. The packaging material of claim 1, wherein the polyethylene is a low density polyethylene.

3. The packaging material of claim 2, wherein the low density polyethylene has a melt index of about 0.1 g/10 to about 2.0 g/10 min.

4. The packaging material of claim 2, wherein the low density polyethylene has a melt index of about 0.2 g/10 min to about 1.0 g/10 min.

5. The packaging material of claim 2, wherein the low density polyethylene comprises about 20 wt. % to about 100 wt. % of the foamed layer.

6. The packaging material of claim 2, wherein the low density polyethylene comprises about 70 wt. % to about 80 wt. % of the foamed layer.

7. The packaging material of claim 1, wherein the filler particles comprise about 10 wt. % to about 40 wt. % of the foamed layer.

8. The packaging material of claim 1, wherein the filler particles comprise at least one filler particle selected from the group consisting of a calcium carbonate, a sodium carbonate, a barium sulfate, a calcium sulfate, a sodium sulfate, a sodium phosphate, a potassium phosphate, and a calcium phosphate, and combinations thereof.

9. The packaging material of claim 8, wherein the filler particles comprise a calcium carbonate.

10. The packaging material of claim 1, wherein the foamed layer has a thickness of about 0.5 mil to about 10 mil.

11. The packaging material of claim 1, wherein the non-foamed layer comprises a high density polyethylene.

12. The packaging material of claim 11, wherein the high density polyethylene has a melt index of about 0.01 g/10 min to about 1 g/10 min.

13. The packaging material of claim 11, wherein the high density polyethylene has a melt index of about 0.40 to about 0.50.

14. The packaging material of claim 11, wherein the high density polyethylene comprises about 20 wt. % to about 60 wt. % of the non-foamed layer.

15. The packaging material of claim 1, wherein the non-foamed layer comprises filler particles.

16. The packaging material of claim 15, wherein the filler particles comprises a calcium carbonate.

17. The packaging material of claim 16, wherein the non-foamed layer comprises about 40 wt. % to about 80 wt. % of the calcium carbonate.

18. The packaging material of claim 1, wherein the packaging material comprises two non-foamed layers on opposite sides of the foamed layer.

19. The packaging material of claim 1, wherein the packaging material comprises two non-foamed layers on opposite sides of the foamed layer and two intermediate non-foamed layers on opposite sides of the foamed layer, wherein the first intermediate non-foamed layer is between the first non-foamed layer and the foamed layer and the second intermediate non-foamed layer is between the second non-foamed layer and the foamed layer.

20. The packaging material of claim 1, wherein the packaging material has a total thickness of about 5 mil to about 20 mil.

21. A packaging material comprising:
an exterior foamed layer comprising high density polyethylene, calcium carbonate filler particles, and foamed cells formed from a chemical foaming agent,
an intermediate foamed layer comprising high density polyethylene, calcium carbonate filler particles, and foamed cells formed from a chemical foaming agent,
a foamed core layer comprising
about 60 wt. % to about 90 wt. % of a low density polyethylene;
about 10 wt. % to about 40 wt. % of a calcium carbonate; and
foamed cells,
an intermediate non-foamed layer comprising high density polyethylene and calcium carbonate filler particles; and
an non-foamed layer comprising high density polyethylene and calcium carbonate filler particles;
wherein the exterior foamed layer, intermediate foamed layer, foamed core layer, intermediate non-foamed layer, and non-foamed layer are a coextruded blown film.

22. A packaging material comprising:
a non-foamed layer; and
a foamed layer comprising a high density polyethylene and filler particles as 40% to about 80% by weight of the foamed layer;
wherein the foamed layer has cavitated cells proximate filler particles and foamed cells resulting from the presence of a foaming agent;
wherein the non-foamed layer and the foamed layer are a coextruded blown film.

23. The packaging material of claim 22, wherein the non-foamed layer comprises a printable material.

24. The packaging material of claim 22, wherein the foamed layer is the innermost layer of the coextruded blown film.

25. The packaging material of claim 22, wherein the foamed layer contributes a surface roughness to a surface of the coextruded blown film upon which bacon or other meat is seated of about 1 to about 7 Sa μm using a 3D optical surface profiler.
